(19) United States
(12) Patent Application Publication
(10) Pub. No.: US 2013/0223766 A1
(43) Pub. Date: Aug. 29, 2013

(54) PLASTIC BAG WITH EASY OPEN MEANS, SYSTEM FOR OPENING BAGS AND METHOD OF MANUFACTURE

(71) Applicant: T.C. Manufacturing Company, Inc., (US)

(72) Inventor: Terry Gebhardt, Kilgore, TX (US)

(73) Assignee: T.C. Manufacturing Company, Inc., Evanston, IL (US)

(21) Appl. No.: 13/776,182

(22) Filed: Feb. 25, 2013

Related U.S. Application Data
(60) Provisional application No. 61/602,800, filed on Feb. 24, 2012.

(51) Int. Cl. B65D 33/00; B31B 29/00; B65B 67/00

(52) U.S. Cl. CPC B65D 33/007; B65B 67/00; B31B 29/00
USPC 383/6; 383/35; 53/384.1; 493/267

(57) ABSTRACT

An easily open-able plastic bag is provided. The bag comprises a notch or opening in its front panel that allows the user to touch the back panel of the bag and pull the bag open. The notch is designed to remove the connection between the front panel of the bag and the means to hold it in place on the dispenser such that the front panel can be freely opened. The rear panel of the bag has a more strenuous connection to the means holding the bag to the dispenser such that the force of opening the bag does not cause the bag to be released from the dispenser. The invention also provides a system to aid in the easy opening of the bag, including a device to help push the notch out from the plane of the bags and a method to manufacture the bags.

### CROSS-REFERENCE TO RELATED APPLICATIONS

This application is related to U.S. Provisional Patent Application No. 61/602,800, entitled T-Shirt Bag With Incorporated Thumb Notch, and is incorporated in full in this application as if set forth in its entirety herein.

### FIELD OF THE INVENTION

The present invention concerns plastic bags for carrying items, dispensing such bags and a method of creating such bags. More particularly the present invention concerns plastic carry-all bags having a means to permit the bag to be opened easily for product placement, a system for allowing the easy opening of the bag and a method of making such bags.

### BACKGROUND OF THE INVENTION

Plastic bags are excellent for carrying items, including heavy items and items that are bulky or hard to hold. Plastic bags have been used to place purchased items within for many years and throughout this time the one constant has been that the walls of the plastic bag, due to static electricity and surface tension, become affixed together such that opening the bag to place items inside becomes difficult. In some instances, users of the bags have been known to lick their fingers to increase the coefficient of friction so as to better grasp one wall of the bag and break it apart from the other wall. While this can be effective, it is generally unsanitary and can cause numbers of bags to be ruined for use with items such as food. As these bags are often used with food, either in grocery stores, delicatessens and fast food restaurants, licking ones fingers to open a bag is an unacceptable solution.

As plastic bags are becoming universally used in so many locations, the problem of the bag's adjacent surfaces adhering to one another as well as one bag adhering to another is a well-known problem. In addition, bags of the type known as T-shirt bags, having handles and an open neck formed therein, have always had their front panel and rear panel sealed together at the neck where an additional tab of material is provided to attach the bags to a hanging dispenser system. By sealing the front to the back at the top and weakening the material at the neck adjacent to the tab, bags of the prior art are kept in place until they are ripped off of the tab and hanger. The act of opening the bag tends to rip the front panel connection to the tab and, once the bag is filled, the act of using their finger or thumb to separate the front layer from the tab via the weakened area and opening it to be filled or completely removing it from the hanger by the handles rips the back panel neck from the tab. Therefore, the connection between the bag neck and tab in both panels has in the past been of approximately the same strength—a weak connection. However, the connection has been strong enough to cause difficulty in separating the front panel from the rear panel to allow the bag to be filled.

Further, while such a connection permits the ready removal of the bags it creates a situation where a bag may be prematurely ripped from the hanger, due to the general weakness of the connection between the bag and the tab and the strength of the adhesion due to friction (and oftentimes cold welding, as known to persons having skill in the art) of the bags together. The prematurely stripped bags are often, thereby either discarded as difficult to use, or taken with the prior bag accidently and also not used, causing waste.

Attempts and solutions to assuage the myriad of problems associated with plastic bags of this type, specifically making them easy to open and fill without have them be wastefully prematurely ripped from their dispensers, has been unsuccessfully attempted on many occasions. The prior art is replete with attempts at solving these problems. Unfortunately while some of the solutions have provided some relief for the problem none of the solutions has been completely successful.

For example in U.S. Pat. No. 4,877,473, Method of Making a Bag Pack, the ongoing problem of dispensing individual bags is recognized and the solution of using a central “pull tab” is proffered—however, it has been found that the pull tab, which is punched into the bag at the time that other necessary cuts to the bag are made, does not easily separate from the body of the bag thereby defeating the purpose of the tab.

U.S. Pat. No. 4,883,450, Process For Making A Single Side Free Plastic Bag, describes a traditional t-shirt bag and an ungussted bag with a cutout that allows the use of a traditional t-shirt wire dispenser. The patent indicates that the primary object of the invention is to provide a method for forming a thermoplastic bag having an easily separable bag mouth opening by providing one side of the bag relatively free for opening from the other side of the bag. The bag described is a bag with the front layer and back layer of the bag connected, keeping the bag mouth closed, but using a weaker connection in the front to allow, if operable as described, an easier opening front. The process described, however, has been found, in practice, to be not possible by the method disclosed; persons having ordinary skill in the art would not discern the method or device shown in the present invention. Further, while the cited patent is quite old, the long felt need for an easy to open dispensable bag is still felt and has not been resolved by that invention.

U.S. Pat. No. 4,946,431, Apparatus for the Manufacture of Block-Sealed Side-Gusseted Bags, describes a simple method for making a bag and forming a cut shape in one layer followed by either a burst of air or requiring an additional mechanical means, to fold the cut piece of film in half to cause the cut to protrude from the plane of the layer of film. This protruding folded-back section of film is then sealed, in the bag's production method, in the cut and seal section of the bag producing machine. The method described, however, is not practical and produces questions as to how the cut film would be removed to permit the making of the bag and then provide an ease in opening. Further, the bags of the '431 patent are straight cut at top and offer no solution to a T-shirt bag design as in the present invention—the inclusion of the necessary handles makes the simplistic approach of the '431 patent unavailing. Further, in light of the age of that patent and the remaining need for such a bag, it is clear that persons having ordinary skill in the art could not adopt this teaching to the problems of T-shirt bags.

I have discovered that by removing the front panel's connection of the neck of the bag from the tab portion and strengthening the connection between the rear panel's connections of the neck to the bag, the bag can be opened filled and removed easily and as intended without wasting additional bags due to the failures described above. Further, by providing an element that helps to push the bags forward and up, to the standard bag hanger, the bags of the present invention become easier to use and cause less waste of bags. The method of creating the bags is new and novel and adds very little to the present costs of producing bags that serve the intended purpose as the method can be completed prior to the use of standard bag forming machinery and methods.

There has been a long-felt need for a plastic bag that is easy to open when needed and maintains its integrity and strength and is dispensed without wasting bags. The present invention provides all of this and more as will be explained below.

Objects and advantages of the present invention will become apparent as the description proceeds.

### SUMMARY OF THE INVENTION

In accordance with the present invention, an easy to open plastic bag, a method of dispensing the bags and a method of creating the bags is provided. The bags comprise a front and a rear panel, the rear panel have a strengthened connection to a tab that holds the bags to a dispensing rack and a front panel that is generally un-tethered at the top to a dispensing tab (as are traditional T-shirt bags) and has a notch cut into the front panel of the bag to allow the user to place a finger at the notch and pull the front panel from the rear panel to open the bag without pulling the bag from the rack until separation is desired.

In a preferred embodiment, the bag comprising a front panel having a front and rear wall, the front panel having a left and right edge, a bottom edge and a top area, a rear panel having a front and rear wall, a left and right edge, a bottom edge and a top area. The front and rear panel initially lie adjacent to one another and are joined together at their respective edges to form a bag. The top area of the rear panel is attached to a tab that holds the bag onto a dispensing rack. The front panel is created with a cut-out in the plastic, in the location where it would otherwise be connected to the tab holding the bags to the dispenser, such that the top area of the front wall of the rear panel is accessible therethrough. Because of the cut-out, the top area of the front panel is easily separated from the top area of the rear panel, allowing the easy opening of the bag. In a preferred embodiment, this is done by touching the front wall of the rear panel through the cut out in the front panel and pulling the front panel out by pushing on the rear wall of the front panel adjacent to the cut out.

Additionally, the front panel, in the area of the cut out, can include high coefficient of friction materials or embossing to cause the plastic to be easier to grasp and the bag easier to open. The preferred type of bag using the present invention would be a T-shirt type bag having gussets and handles of types know to those having skill in the art.

In another aspect of the present invention a system for opening one bag at a time of a pack of plastic bags is provided. In the preferred embodiment a dispenser for holding a pack of bags is provided the dispenser includes a tab holder for holding the plastic bags and a curved fitment, adjacent the tab holder, having a surface that extends curvilinearly out from about the tab holder. It will be understood that the fitment could be made angularly, pushing the stack of bag out and up as with the curvilinear fitment, without departing from the novel scope of the present invention. When a pack of bags is attached to the dispenser, by the bag tab, the fitment element of the dispenser causes the top of the pack of bags to be urged outward and upward such that the open front panel of the front-open bag at the front of the pack is urged out to allow the bag to be more easily opened. It will be understood that the curved fitment can be made modularly such that it can be added to existing bag dispensers. In the use of the present invention, preferable the bags are connected together by a header, which can be attached to the dispenser.

The present invention further includes a method of making an easy to open bag feature that can be added as a process in the well known method of making plastic bags. The process includes the steps of providing folded plastic sheeting formed into a V to create a film with a folded edge and a loose edge corresponding to an upper layer of film and lower layer of film and then inserting, via the loose edge side of the film, a punching unit so as to cut a notch into the upper layer of film. The film is then slit sealed to close the loose edge and fed into a convention bag making machine to produce the desired bag with the notch cut into the front later. In one embodiment, a step of folding over the notch and securing the notch to the upper layer of film with a heat seal or cold weld prior to entry into the conventional bag machine is done.

A more detailed explanation of the invention is provided in the following description and claims and is illustrated in the accompanying drawings.

### BRIEF DESCRIPTION OF THE DRAWINGS

FIG. 1 is a perspective view of bags of the present invention positioned in a dispensing rack;

FIG. 2 is an elevational view of one embodiment of a bag made in accordance with the present invention;

FIG. 3 is an elevational view of the embodiment of FIG. 2, more clearly showing the front layer of a bag made in accordance with the present invention;

FIG. 4 is a perspective view showing the front of a bag made in accordance with the present invention being opened relative to the back of the bag;

FIG. 5A-5F show variations to the opening portions of bags made in accordance with the present invention;

FIG. 6 is perspective view of the variation shown in FIG. 5B;

FIG. 7 is a perspective view of the bag of FIG. 5B showing the approach to opening the bag;

FIG. 8 is a perspective view of the bag of FIG. 5B in an open/loading position;

FIG. 9 is a perspective view of a standard bag dispenser;

FIG. 10 is a perspective view of a dispensing element of the present invention;

FIG. 11 is a perspective view of the dispensing element of FIG. 10 in place on a bag dispenser of FIG. 9;

FIG. 12 is a perspective view of a package of bags in place on a bag dispenser equipped with the dispensing element of FIG. 10;

FIG. 13 is a plan schematic of the method of creating the bags of the present invention;

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

A. Plastic Bag with Notch Area

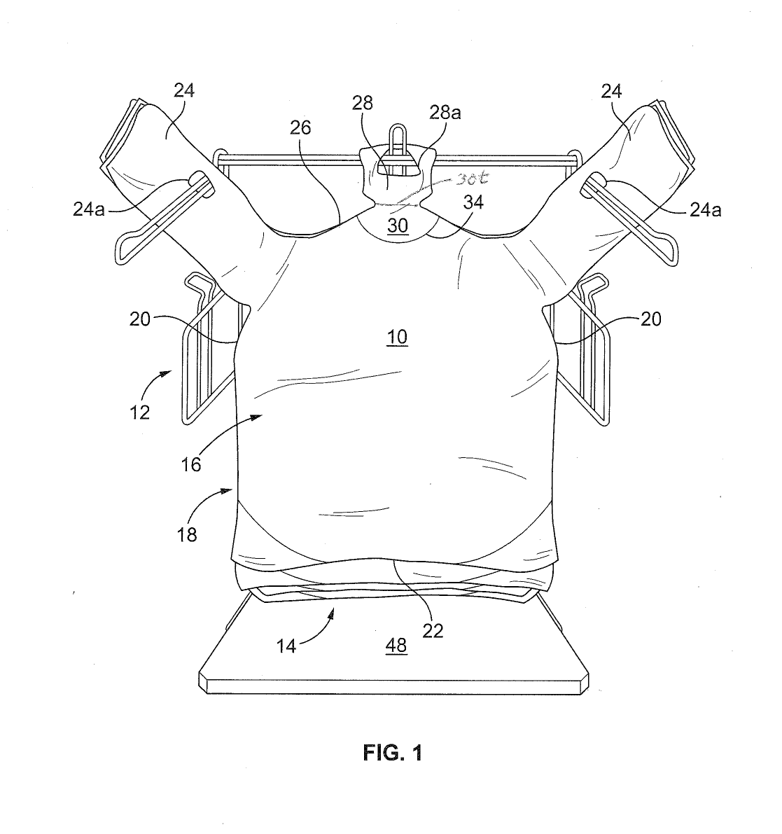

Referring now to FIG. 1, a plastic bag 10 of the T-shirt variety is shown on a dispenser 12 or rack. It will be seen that the plastic bag 10 is included in a stack of bags 14; however it will be understood that improvements described herein are effective as well when using one bag on its own. As shown in FIG. 1, each bag 10 includes a front 16, a back 18, sides 20, a bottom 22, handles 24, a neck portion 26, a tab 28, having a slot 28a. As will be seen most advantageously in FIG. 3, a portion of material, or notch, 30 has been removed between tab 28 and neck portion 26, defined by a cut line 34 (FIG. 1). Tab 28 in prior art bags is attached to neck portion 26 with the connection being weekend by the removal of a material along generally arcuate line—generally seen as a dashed strip of alternating material and removed material to form a line of weakness. This line of weakness, or tear zone 30T, allows the bag to be separated from the tab. In prior art bags, the tear zone is generally the same for the front panel of the bag and the rear panel of the bag such that when force capable of ripping the front panel free, so that items can be placed in a bag, the rear panel often is released as well, making the bag difficult to fill (as it is falls free from the dispenser 12 or front and rear panels, disconnected from tab 28, fall together and must be again separated in the presence of friction and static adhesion). In the present invention, as shown, the front panel is free from connection with tab 28 and the rear panel has a tear zone that is connected by larger amounts of plastic so that it is more firmly held and will not so easily release the rear panel.

The strengthening of the rear tab connection and the removal of the front tab connection is very important to the functioning of the present invention and to a savings of plastic bags. If fewer bags are wasted then the use of plastic bags becomes more ecologically acceptable. It will be understood that the strengthening of the connection between the bag and the tab of a conventional (prior art) bag would not be effective as a means to improve such bags, as the strengthening of both the front and rear tab connections would cause the bag to be more difficult to remove and the strengthening of just one of the connections (either front or back) would provide no improvement to the problem of opening the bag over the prior art.

In creating a bag 10, of the present invention, it will be understood that the preferred material is polyethylene due, among other reasons, to its minimal cost, its strength, and its machine-ability. Polyethylene film can be made in many different forms, each of which is useable for this type of bag. Mono-layer film, which means one extruded layer, in either, a film which is 100% virgin material, a blend of several different polyethylene resins of different densities, or a blended film of virgin polyethylene resins of different densities, which could include post industrial reclaimed material or post consumer material. Each of the films listed can be customized with the appropriate color concentrate to meet application requirements. These films can also be coextruded as multilayer films. The listing of these films is not meant to be a limitation on the present invention. In addition, it will be understood by persons having ordinary skill in the art that any other material having the capability to be cut, sealed and when the bags are created, placed on a header or collated, such as polypropylene, nylon, polyester, laminated films made up of the films listed, can be used without departing from the novel scope of the present invention. Further, the preferred thickness of the material used to create bags of the present invention ranges from 8 microns (0.3 mil) to 25 microns (1 mil) Some considerations for the preferred thickness are the costs compared to other bag types and materials.

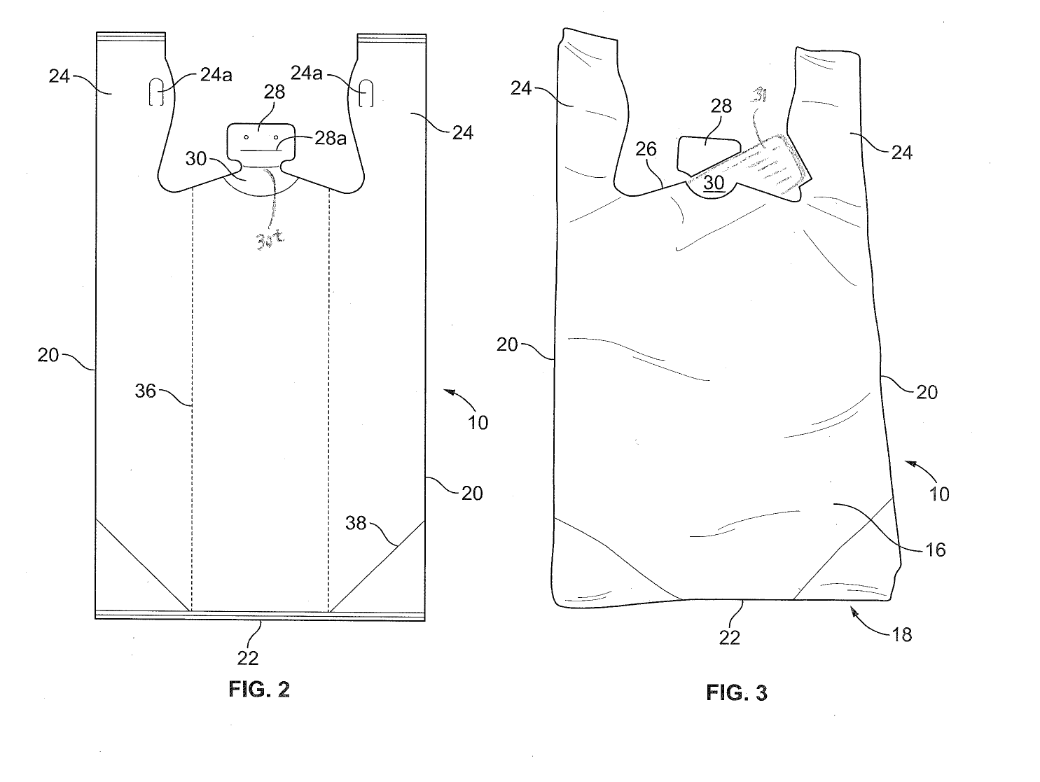

As shown in FIG. 2, the bag 10 of the present invention can be made with gussets 36 to allow the bag to fold flat when not in use or when stacked with other bags, and when opened for use can assume a more squared shape for greater volume. In some embodiments the bag 10 can also be provided with angle seals 38 to allow the bag to stand. FIG. 2 also shows slot 28a in tab 28 as well as handle holding openings 24a for use with certain types of bag dispensers 12 or racks. It will be seen that a higher strength tear zone 30t is created on the back panel 18 of bag 10 to provide a strengthened connection as will be described in more detail below. In FIG. 3, an object 31 has been placed between the front panel 16 and rear panel 18 so as to more clearly show that notch 30 creates a separation between the front panel 16 and tab 28 at all times.

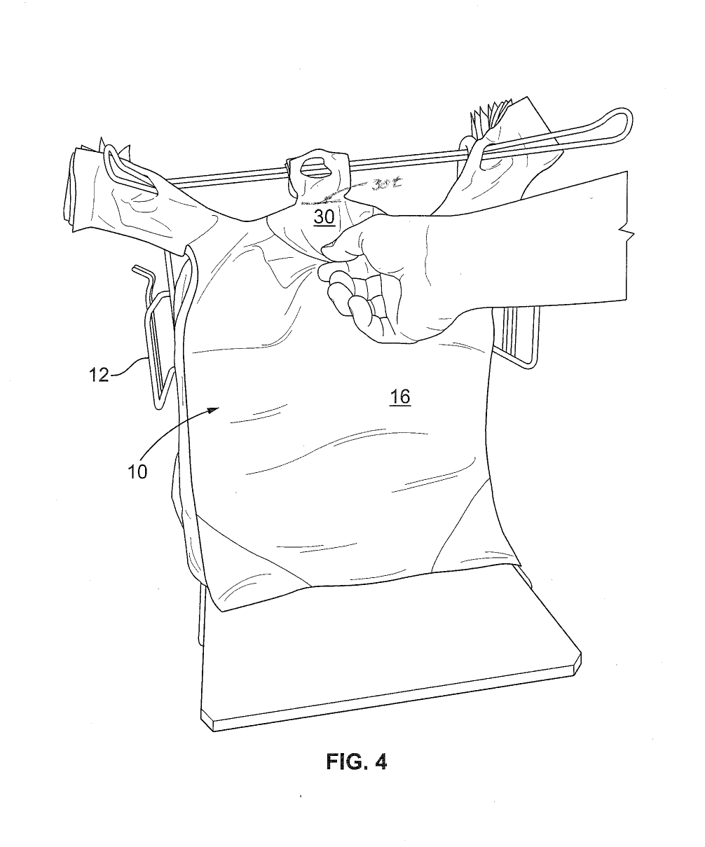

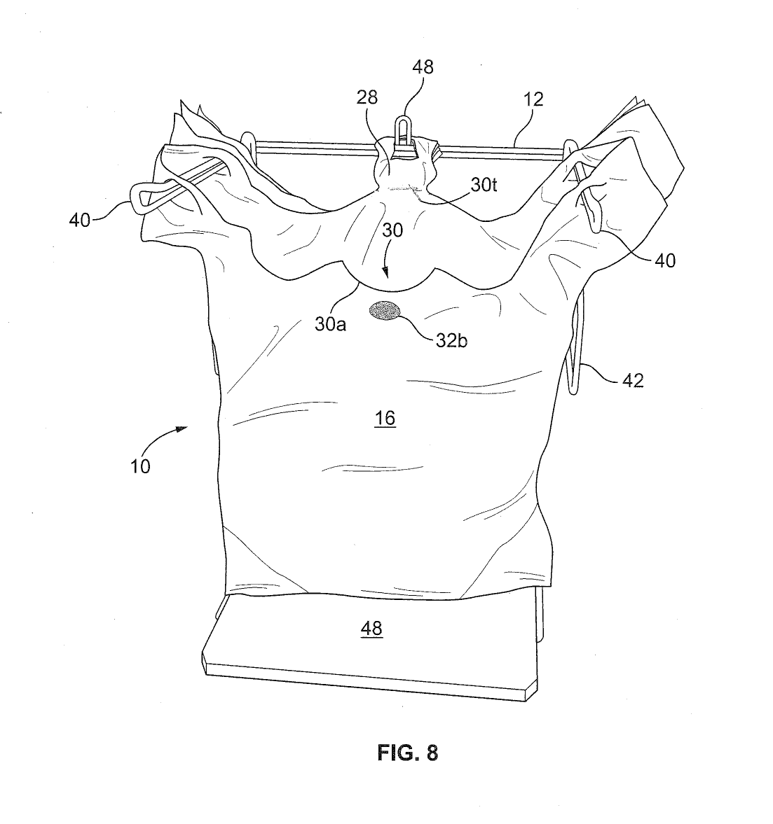

Referring to FIG. 4, a method of opening a bag made in accordance with the present invention is shown. As shown, when bags 10 are on dispenser 12, the front panel 16 of a bag 10 can be easily grasped by placing a finger within the opening created by notch 30 and dragged down until front panel 16 is reached and then pulled forward. As shown in FIG. 4, the material surrounding notch 30 can then be grasped and pulled out to open the bag as best seen in FIG. 8.

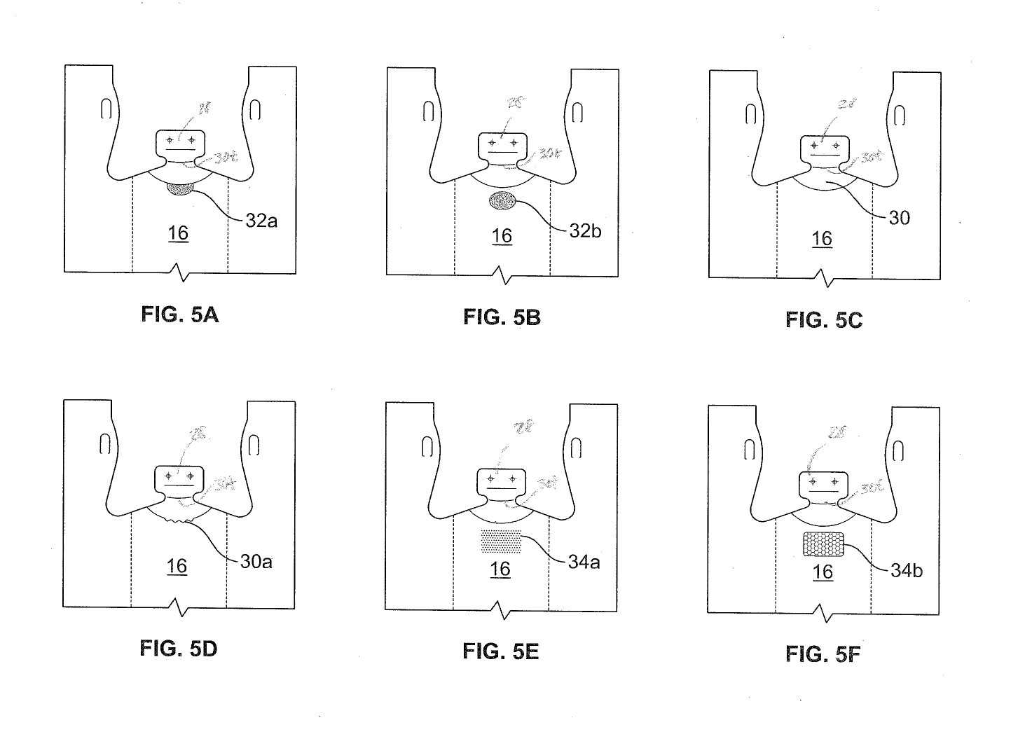

FIGS. 5A through 5B variations of the area of bag 10 beneath notch 30 are shown. It will be understood that these variations can offer some improvement to the ease of opening the bag, but that a bag of the present invention without any additional enhancement, as shown in FIG. 5C offers sufficient improvement over the prior art. As shown, FIGS. 5A and 5B show areas where spots 32 of high coefficient of friction (COF) inks, of a type known to persons having skill in the art, have been applied to the front panels of the bags either immediately adjacent notch 30 (FIG. 5A) or slightly spaced away (FIG. 5B). It will be understood by persons having ordinary skill in the art that in addition to ink, a spray with a repositionable adhesive to create a high COF area can be used without departing from the novel scope of the present invention. Further, the placement of the high COF ink spots 32 can be of any size or shape that will assist in the opening of bag 10 without departing from the novel scope of the present invention. In one preferred embodiment the spot 32 of high COF ink is incorporated into the design or decoration of the bag so as to blend in with the desired message or image of the bag provider. As shown in FIG. 5D a distorted edge can be created, in various ways known to persons having ordinary skill in the art, which causes the edge of notch 30 to protrude slightly above the plane of front panel 16. In this way, the user can more easily slide a finger, or other device, under front panel 16 to pull the panel out from the rear panel to open the bag.

FIGS. 5E and 5F show another alternative, which are variations of distorting the texture of the front panel 16 adjacent to notch 30. As can be seen the coefficient of friction of the designated areas in FIGS. 5E and 5F has been increased by producing either an area of pin holes 34a or an embossed area 34b. It will be understood, just as with the high COF ink, that these areas can be included with or concealed by the decoration or message of the bag and or can be of various sizes and shapes, while providing assistance in opening the bag and without departing from the novel scope of the present invention. The use of special dies or presses as well as ink stamping, double sided dies, or high levels of calcium carbonate at a large micron size to increase roughness of film, to create any of these effects is well known to persons having ordinary skill in the art, their application to aid in opening bags is new and novel. Further, it will be understood that additional help in opening bag 10 can be achieved by using a combination of two or more of these enhancements together. Further, as the enhancements can be added to a very small portion of the bag, it will be understood that the integrity of the bag will not be compromised by the inclusion of such enhancements. In addition the following are other enhancements that can be made to the notch and notch area without departing from the novel scope of the present invention:
i. Print “Open Here” in the area below the thumb notch with high COF ink, tacky ink or repositionable adhesive. The area can take on any from but is preferably at least 1″ in width and ¾″ in height.
ii. The area directly under the thumb notch is deformed either by embossing or a method such as vacuum. This could also be accomplished by be punctured by sharp needles or pins.
iii. Creating a larger opening, which in some instances is preferred and thereby allowing the use of a t-shirt die that slightly welds the stack of bags while it cuts through them and thereby acts as a type of cold weld.
iv. The use of a single cold weld in the center of the bag just below the thumb notch to assist in opening the next bag and thereby making other cold welds unnecessary.

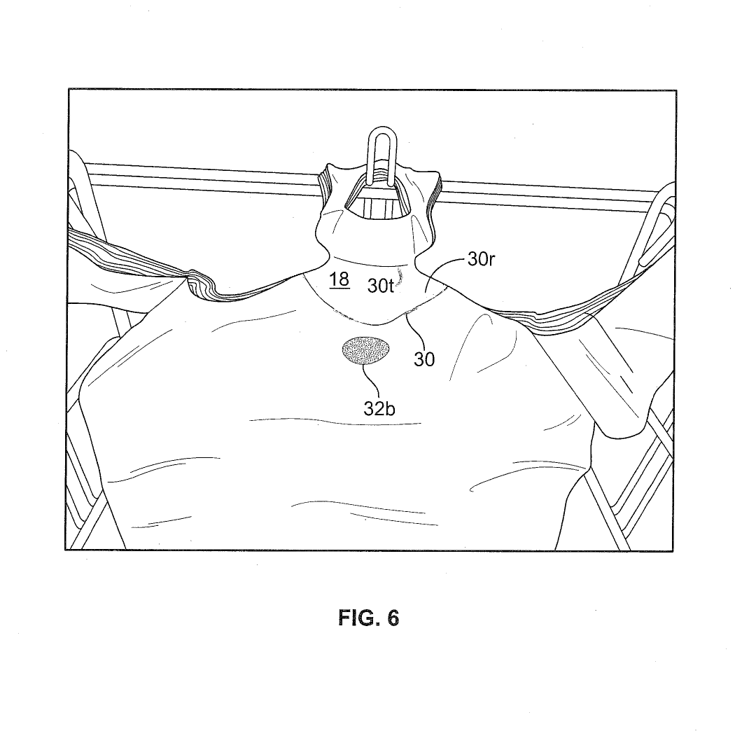

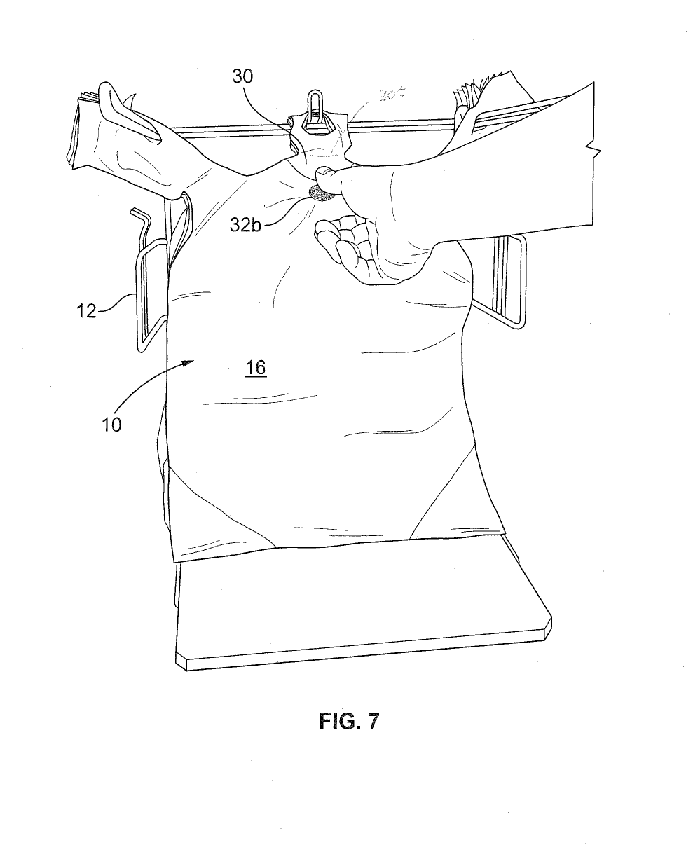

Referring to FIGS. 6, 7 and 8 a demonstration of the use of the notch 30 and high COF ink spot 32b is shown; it will be understood that the demonstration would be as effective with any of the enhancements described above, and that the demonstration is not meant to be limiting. The user will grasp the bag 10 at or about notch 30 and spot 32b and pull the bag 10 open. As area 30R, on the rear panel 18 has been made with a higher than usual (for ordinary T-shirt bags) tear zone 30T, pulling front panel 16 to open bag 10 will not tend to cause bag 10 to pull off of tab 28 as readily as with prior art bags; thereby saving bags from falling prematurely from stand 12 or from being otherwise discarded as being difficult to open and/or fill.

Referring again to FIG. 8, it can be seen that notch 30 is made in accordance with the bag shown in FIG. 5D, that is, with a distorted edge. It will be understood, as described above, that the use of the distorted edge 30a either alone or in conjunction with a high COF ink spot 32b the ease of opening the bag will be increased. As shown in FIG. 8, tear zone 30t, comprising a more hardy union of bag 10 to tab 28 thereby allowing the user to use more force, if desired, to open bag 10, without pulling the rear panel 18 of the bag from tab 28. When the bag is finally removed, tearing zone 30t from tab 28 and pulled free from rack 12, the use of cold welds, as know to persons having ordinary skill in the art, in association with notch 30 (wherein the front panel is not attached to tab 28) will have the added benefit of tending to pull open the next bag 10 in the bag pack. It will also be understood that at times the elimination of cold welds so as to not inhibit opening and the possibility of dispensing more than one bag at a time can also be done without departing from the novel scope of the present invention.

It will be understood that while bag 10 remains connect to tab 28 the bag can be more easily filled with products; if bag 10 becomes completely loosened from tab 28 there is an increased likelihood that the bag will not be used and may be discarded due to the difficulty of opening the bag as a result of the adhesion of the front and rear panel together. It is well known that a closed plastic bag requires considerable effort to open.

B. Dispensing Enhancements

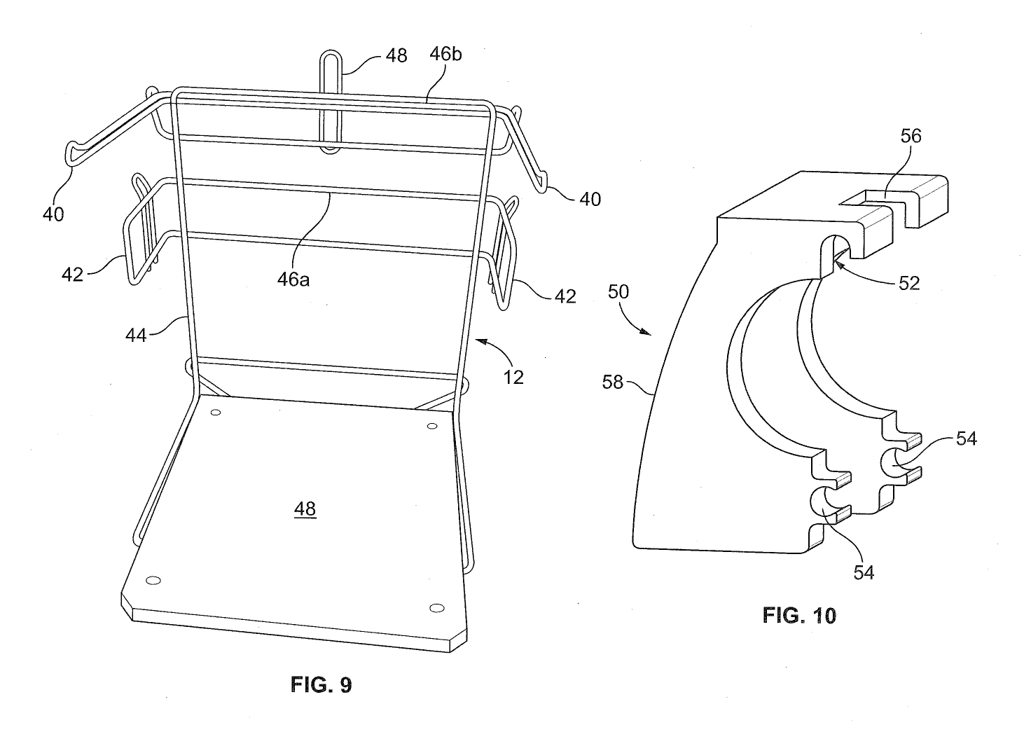

In an additional enhancement to the system of opening plastic bags for use, I have further devised an addition to the standard bag dispenser 12, shown in FIG. 9. A standard bag dispenser 12 is typically designed as shown in FIG. 9 and comprises arms 40 through which the handles 24 of bag 12 can be held (often through an opening 24o in handles 24, as shown in FIG. 1); a side support bracket 42 on each side of rack dispenser 12, to help contain the bags and products being placed in the bag. While it will be understood that a dispenser 12 can be made without side supports 42, so as to accommodate larger bags or different types of bags, it is desirable to use existing dispenser's 12 with bags of the conventional size and so as to avoid the need to replace existing dispensers currently in use. Dispenser 12 also has a back 44 with various rails 46 adjacent the handle arms and side supports (often being made integrally with these); and a tab holder 48 attached to back 44, through which tab slot 28a of tab 28 is attached to allow the loading system to operate, as know to persons having ordinary skill in the art. Dispenser 12 can also include a base 48 onto which the bag and its contents will rest (while remaining attached to dispenser 12) while it is being filled and before it is removed from dispenser 12 and taken away by a user.

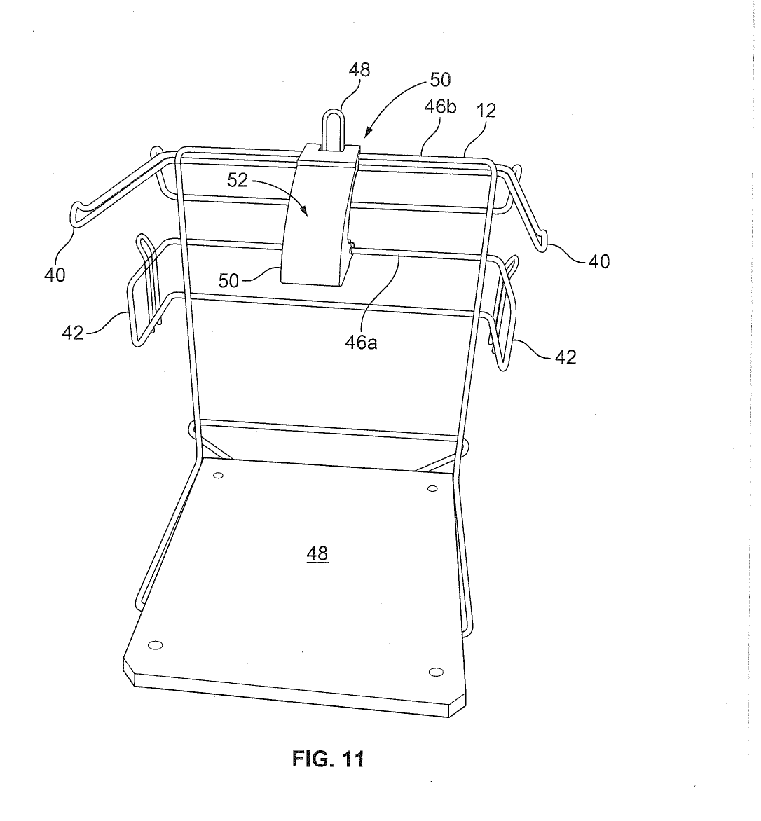

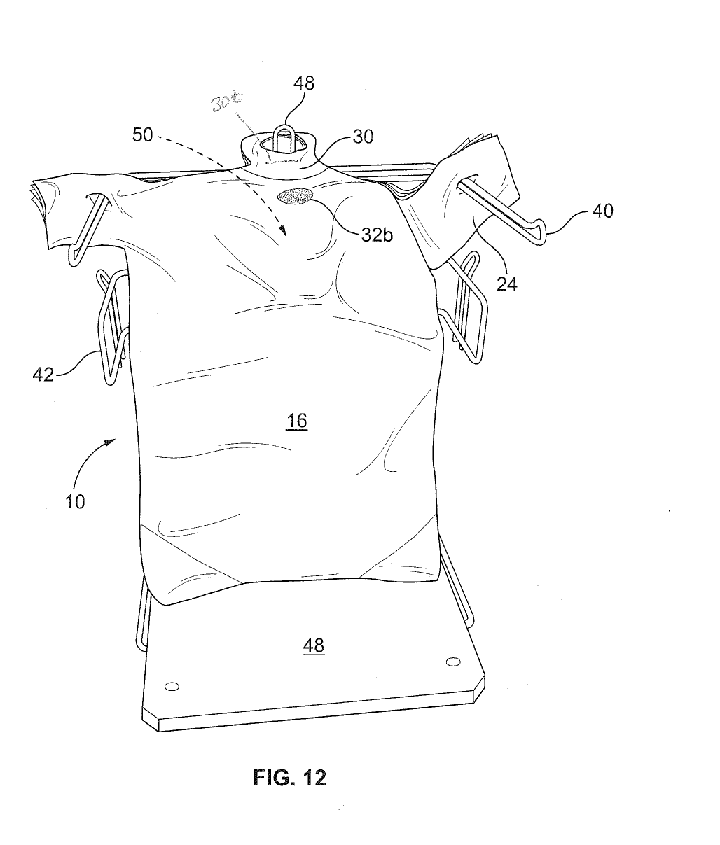

The use of dispenser 12, and the various components, can be seen in many of the figures herein. FIG. 10 shows the additional component, a curved fitment 50, having attachment openings 52 to fit onto dispenser rails 46 and band clip elements 54 to attach to dispenser rails 46a and a tab opening 56, through which tab 28 can be fitted, that is useful to help in opening the bags. Curved fitment 50 also comprises a surface 58 onto which tab 28 of a bag pack can rest and be pushed forward. Referring to FIGS. 11 and 12, when bags 10 are placed on a bag dispenser 12 made in accordance with this aspect of the present invention, the curved fitment 50 will put stress on the bags 10 on the dispenser 12 just below the thumb notch 30 area, thus preopening the bags 10 and separating the thumb notch 30 area from the back layer 18 sufficiently to create a grip area along the edges 30a of thumb notch 30. The pre-opened position can be seen as the raising of edge 30a above the plane of the plastic of front panel 16, providing a ridge that will be caught by a user's finger sliding on the surface of panel 18 within notch 30; the continued movement of the user's finger will catch edge 30A and pull panel 16 away from panel 18 opening the bag 10.

In the use of the fitment 50 bags having the thumb notch area folded back into bag (not removed) can be easily accommodated as well as bags with thumb notched area folded outward to create a tab

C. Method of Manufacture

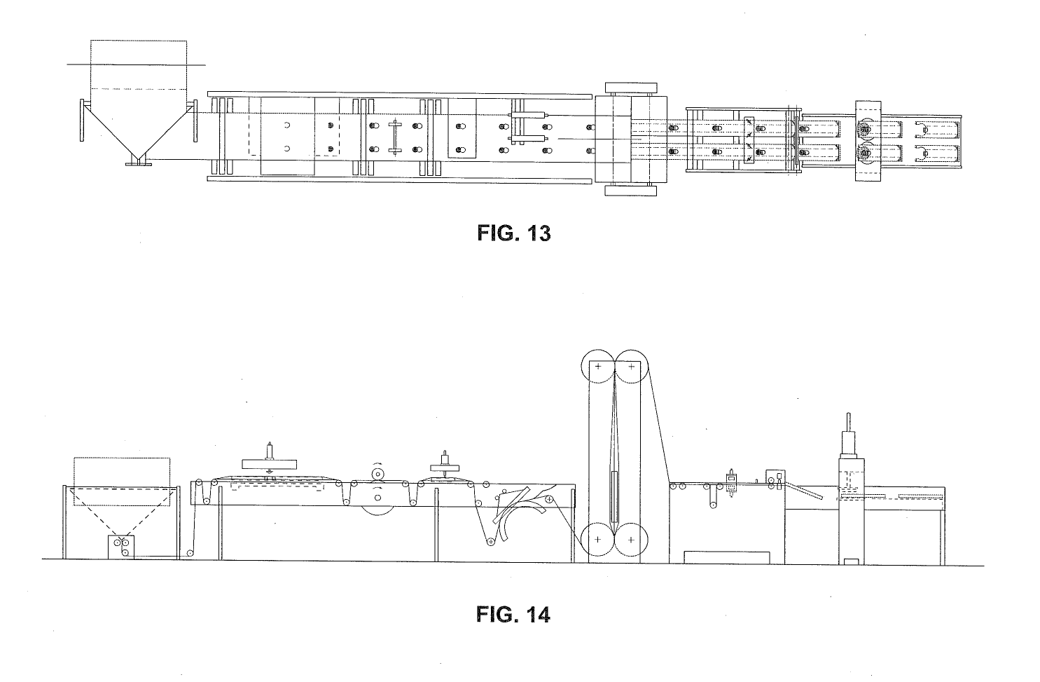

Referring now to FIGS. 13 and 14, a method of manufacturing bags 10 of the present invention is shown. As shown, extruded and printed rolls of single wound plastic sheeting are unwound and V-folded creating film with a folded edge and a loose edge. Inserted in the film from the loose edge is a Mal Punch style unit which cuts a ¾ to ⅞ circular thumb notch pattern in the upper layer of film. It will be understood that other types of punches or dies can be used to create the thumb notch without departing from the novel scope of the present invention. The cut area of the film is drawn through a set of overrunning wheels that fold the thumb notch cut pattern back over the upper layer of film. The folded over thumb notch section is then secured to the upper layer of film by means of a heat seal or cold weld so that it will travel through the rest of the process without incident and not impeding the speed of the machine. It will be understood by persons having ordinary skill in the art that the thumb notch feature can be made using several methods including, for example: a rotary die that has a half moon die or complete circle or elliptical in it the shape and size of the thumb notch to be produced or a saw tooth punch the shape of a half moon or a completely cutout circle or elliptical shape. The notch can be made in any shape just so that the size of the cutout is larger than the tabbed area and acts to free the front layer of film from the bag layer of film.

The film is then slit sealed (a heated blade assembly) to form multiple lanes and to close the loose edge, which forms a small amount of trim which is then discarded and or recycled. Next, the film is post gusseted using a manual type gusseting to form pleats or gussets on each side of the film, known to those skilled in the art.

The film then enters a traditional t-shirt bag machine which has been fitted with an angle seal attachment. The angle seals are applied the film, which then is registered with the sealing, cut off and stacking section of the bag machine and bag is formed to the required length specifications and stack count. The stacked bags are then transferred under a punch press, which is known those skilled in the art, where the top of the bag is die cut to form handles and dispenser means. This punching action also removes the piece of film that is secured to the upper layer of film leaving the loose thumb notch exposed on each bag. The bags in the collated form are then transferred to a packing station where they are placed in a box for shipment. These bags can be formed in a loose stack or a collated stack according to the application requirements.

It will be understood by persons having ordinary skill in the art that the manufacture of the bags can be enhanced using any one or more of these additional methods, without departing from the novel scope of the present invention.
Vacuum drums to separate film and allow for punching in the front layer only
Floating former
“C” folded film . . . one up or separate rolls to give you an open edge in which to insert the punching attachment
Deformation of from edge using vacuum
Creating a bubble in the film using vacuum and then at another station cutting the bubble off creating the thumb notch area.
Use knife profile such that the inside of the t-shirt cut out creates a temporary cold weld of one back layer to the next.
Use of rotary die technology to remove only the front layer of film.

In addition, persons having skill in the art will recognize that the following additions and changes to the method of making bags of the present invention can be utilized without departing from the novel scope of the present invention:
b. The film is extruded and printed as sheeting then when unwound on a bag converting machine it is v-folded to form a v-folded sheet of specified width with one edge of the film open so that a punch unit of a certain configuration can be inserted from the open edge to cut the thumb notch in a single or multiple lane configuration. The film is then slit sealed (continuous heat seal that cuts and seals in a continuous motion) into single or multiple lane configuration where then the gusset is formed in a mechanical manner before it enters a conventional t-shirt machine known to those skilled in the art.
c. Same method as in (a) but with multiple rolls of film to form multiple lanes instead of a single sheet of film
d. Same method as described in (a) where two individual sheets are used instead of having to v-fold the sheeting film The thumb notch is formed in a single layer then the two layers are brought together, and the top layer is registered to the bottom layer. They are then slit sealed, gusseted and then enter into a conventional bag converting machine
e. A method described in (a-c) where the thumb notch is not removed from the film in one or more stations but is cut as a half moon and folded inward to create a slightly raised area for the a thumb to use as an opening edge.
f. A method described in (a-c) or the use of tubing instead of sheeting where the thumb notch is formed by using a high suction that deforms the film through an aperture shaped like the thumb notch, where the deformed section is sliced off the bag in an adjoining station to form the thumb notch opening. The film is then gusseted and enters the conventional bag converting machine.

Although an illustrative embodiment of the invention has been shown and described, it is to be understood that various modifications and substitutions may be made by those skilled in the art without departing from the novel spirit and scope of the invention.

What is claimed is:

1. An easy to open plastic bag comprising:
a front panel having a front wall and a rear wall, the front panel having a left edge, a right edge, a bottom edge and a top area;
a rear panel having a front wall and a rear wall, the rear panel having a left edge, a right edge, a bottom edge and a top area;
the front panel and rear panel initially lying adjacent to one another and joined at their respective edges to form a bag;
the top area of the front panel having a cut out in the plastic such that the top area of the front wall of the rear panel is accessible therethrough;
wherein the top area of the front panel is easily separated from the top area of the rear panel, opening the bag, by touching the front wall of the rear panel through the cut out in the front panel and pulling the front panel out by pushing on the rear wall of the front panel adjacent to the cut out.

2. The easy to open plastic bag of claim 1, wherein the bag is opened by pulling on the front panel adjacent to the cut out therein.

3. The easy to open plastic bag of claim 1, wherein the bag includes gussets.

4. The easy to open plastic bag of claim 1, wherein the bag includes handles.

5. The easy to open plastic bag of claim 1, wherein the plastic is polyethylene film.

6. The easy to open plastic bag of claim 1, wherein the bag includes a high coefficient of friction section on the front panel adjacent to the cut out.

7. The easy to open plastic bag of claim 1, wherein the high coefficient of friction section is comprised of ink.

8. The easy to open plastic bag of claim 1, wherein the high coefficient of friction section is comprised of deformations in the bag material.

9. The easy to open plastic bag of claim 1, wherein the thickness of the material used to make the bag is between 8 and 25 microns.

10. A system for opening one bag at a time of a pack of plastic bags, each bag comprising a plastic bag having a front panel and a back panel joined together to form a bag, the front panel and back panel together being generally open at the top of the bag with the back panel being removably connected to a tab to form a front-open bag, the system comprising:
a dispenser for holding a pack of front-open bags, the dispenser having a tab holder; and,
a pack of front open bags connected to the dispenser by at least the tab being held by the tab holder, wherein the connection of the back panel to the tab includes a strengthened tear zone to prevent the bag from being pulled from the dispenser when the bag is opened.

11. A system for opening one bag at a time of a pack of plastic bags, each bag comprising a plastic bag having a front panel and a back panel joined together to form a bag, the front panel and back panel together being open at the top of the bag with the back panel being removably connected to a tab to form a front-open bag, the system comprising:
a dispenser for holding a pack of front-open bags, the dispenser having a tab holder and a curved fitment adjacent the tab holder, the curved fitment having a surface that extends curvilinearly out from about the tab holder; and,
a pack of front open bags connected to the dispenser by the bag tab being held by the tab holder, wherein the curved fitment of the dispenser causes the top of the pack of bags to be urged outward and upward such that the open front panel of the front-open bag at the front of the pack is urged out to allow the bag to be opened.

12. The system for opening one bag at a time of a pack of plastic bags of claim 11 wherein the bags are T-shirt bags.

13. The system for opening one bag at a time of a pack of plastic bags of claim 1 wherein the curved fitment is modular and can be removed from the dispenser.

14. The system for opening one bag at a time of a pack of plastic bags of claim 11 wherein the front-open bags are connected together by a header.

15. The system for opening one bag at a time of a pack of plastic bags of claim 11 wherein the bags further comprise a zone of high coefficient of friction means to assist in opening the bags.

16. The system for opening one bag at a time of a pack of plastic bags of claim 15 wherein the high coefficient of friction means is created with ink.

17. The system for opening one bag at a time of a pack of plastic bags of claim 15 wherein the high coefficient of friction means is created by manipulating the plastic panel.

18. A method of making an easy to open bag feature comprising the steps of:
providing plastic sheeting;
folding the plastic sheeting into a V to create a film with a folded edge and a loose edge corresponding to an upper layer of film and lower layer of film;
inserting via the loose edge side of the film a cutting unit;
cutting a notch into the upper layer of film with the cutting unit;
slit sealing the film to close the loose edge; and
sending the sealing film to a conventional bag former.

19. The method of making an easy to open bag feature of claim 18 including the steps of folding over the notch and securing the notch to the upper layer of film with a heat seal or cold weld.

20. The method of making an easy to open bag feature of claim 18 wherein the cutting means is a punch.
